(19) United States
(12) Patent Application Publication
(10) Pub. No.: US 2021/0205917 A1
(43) Pub. Date: Jul. 8, 2021

(54) METHOD AND DEVICE FOR JOINING HOT SLABS BY MEANS OF FRICTION WELDING

(71) Applicant: SMS GROUP GMBH, Düsseldorf (DE)

(72) Inventor: Markus SCHELLMANN, Siegen (DE)

(21) Appl. No.: 16/755,401

(22) PCT Filed: Oct. 1, 2018
(86) PCT No.: PCT/EP2018/076605

§ 371 Date: Apr. 10, 2020

(30) Foreign Application Priority Data
Oct. 30, 2017 (DE) 10 2017 219 416.2

(51) Int. Cl. B23K 20/12; B21B 15/00

(52) U.S. Cl. CPC B23K 20/129; B23K 2103/18; B21B 15/0085

(57) ABSTRACT

A method for joining hot slabs, which can be fed in succession to at least one roll stand. Joining sides of the hot slabs facing each other are, by pendular friction welding and/or vibration friction welding, simultaneously integrally bonded to a single metal intermediate piece arranged between the joining sides, by oscillatingly moving the intermediate piece at least largely parallel to the joining sides, while the joining sides are pressed against the intermediate piece and are held stationary; or simultaneously integrally bonded to at least one separate metal intermediate piece each, the intermediate pieces being arranged between the joining sides, by pressing the intermediate pieces arranged in series between the joining sides and oscillatingly moving the intermediate pieces at least largely parallel to the joining sides and oppositely to each other, while the joining sides are pressed against the intermediate pieces and held stationary.

The invention relates to a method and to a device for joining hot slabs which are able to be fed in succession to at least one roll stand.

It is known for hot slabs to be joined to one another, for example to enable continuous hot-rolling of successive hot slabs without the rolling process having to be interrupted for threading-in or threading-out the respective hot slab to or from a roll stand or a roll train, respectively. Thinner final thicknesses can be achieved by dispensing with the threading-in. Moreover, the risk of so-called risers occurring and of the rolled material wandering is reduced. Since threading-in and threading-out of hot slabs is no longer required, the waste which is usually associated with threading-in and threading-out and is generated by the severing of end portions of hot slabs that have not been fully reduced to the desired thickness at the start or the end of rolling, respectively, is also reduced. The joining of hot slabs ultimately enables an increase in the productivity of a roll stand, or of a roll train, or of a correspondingly equipped metallurgical plant, respectively.

EP 0 492 368 A2 relates to a device for butt-joining by means of arc welding or induction heating steel sheets which are moving on a conveyor device.

JP 2014 050 852 A relates to the welding of slabs while using a welding filler material and an electric welding installation.

EP 3 064 307 A1 relates to a system which has a double-sided adapter from a Ni-based alloy, said adapter on each of the two sides being joined to different steel types. The joining of the different steel types by way of the adapter is at least partially generated by friction welding.

EP 2 474 382 A1, JP H11342 481 A, JP 2008 036 648 A, and WO 2009/117246 A1 relate in each case to a friction stir welding technique for joining metal products.

JP 03 129 042 B2 relates to a method for joining hot slabs in which mutually facing joining sides of the hot slabs are joined directly to one another by friction welding.

The masses to be moved when directly joining hot slabs by means of friction welding are typically considerable. Therefore, correspondingly great forces have to be applied in order for the friction welding to be able to be carried out in the first place. Moreover, the reactive forces of the applied forces have to be absorbed in terms of construction. In order for the durability of a device used for friction welding to be ensured, the components of said device have to be embodied so as to be relatively large and robust, this being associated with considerable complexity and a considerable space requirement. Moreover, the energy requirement of a corresponding device and the complexity in terms of process technology are relatively high. This renders the economic viability of a direct friction welding method questionable. Furthermore, the movements of the hot slabs are not rectilinear but as a matter of principle said movements oscillate in a circular manner about a center. The mutual spacing of the joining sides of the hot slabs herein is not uniform across the entire welded region, or the width of the hot slabs, respectively, and in most instances varies periodically during the friction welding. For these reasons, the welding outcome of a direct friction welding method cannot be considered ideal.

JP H08 10803 A discloses a method for connecting sheet bars that are rolled in a roughing mill and successively feedable to at least one rolling mill. In this case, mutually facing connection sides of the rolled sheet bars are simultaneously material-lockingly connected by friction-welding by two metallic intermediate pieces arranged in parallel between the connection sides, in that the intermediate pieces are oscillatingly moved parallel to the connection sides.

It is an object of the invention to enable the joining of hot slabs by way of a lower requirement in terms of energy and less constructive complexity and with an improved welding outcome.

This object is achieved by the independent patent claims. Advantageous design embodiments are set forth in the description hereunder, the dependent patent claims, and in the figures, wherein said design embodiments may constitute a refining, in particular also preferred or advantageous, aspect of the invention in each case individually or in various technically expedient combinations of at least two of these design embodiments with one another. Here, design embodiments of the method can correspond to design embodiments of the device, and vice versa, even if this is not explicitly pointed out hereunder in the individual case.

According to a first method according to the invention for joining hot slabs which are able to be fed in succession to at least one roll stand, mutually facing joining sides of the hot slabs by pendular friction welding and/or vibration friction welding are simultaneously joined in a materially integral manner to a single metallic intermediate piece disposed between the joining sides in that the intermediate piece is moved in an oscillating manner at least largely parallel to the joining sides while the joining sides are pressed against the intermediate piece and held in a locationally fixed manner, wherein the single intermediate piece is either separated in advance from one of the warm slabs or an existing remaining slab is used as the single intermediate piece.

According to a second method according to the invention the hot slabs are simultaneously joined in a materially integral manner to in each case at least one separate metallic intermediate piece disposed between the joining sides in that the intermediate pieces disposed in series between the joining sides are pressed against one another and are moved in a mutually counter-oscillating manner at least largely parallel to the joining sides while the joining sides are pressed against the intermediate pieces and held in a locationally fixed manner.

According to the invention, the joining sides, or the joining faces at the end sides, respectively, of the hot slabs by pendular friction welding and/or vibration friction welding are indirectly joined to one another by way of one, two, or more, intermediate pieces. The hot slabs herein are held in a locationally fixed manner. Only the single intermediate piece is moved in an oscillating manner, or only the separate intermediate pieces are moved in an oscillating manner, respectively. Since the intermediate piece, or the intermediate pieces, respectively, has/have significantly less mass, for example a mass which is less by multiples, than one of the hot slabs, the joining of the hot slabs can take place at a lower energy requirement and with less complexity in terms of construction since less mass has to be moved, for example in comparison to JP 03 129 042 B2. On account thereof, the production of hot slabs can be implemented in a more cost-effective manner and while using a device which requires less installation space, thus is configured to be more compact. The method according to the invention can also be implemented in a simpler manner in terms of process technology.

As opposed to direct friction welding of hot slabs, the flat joining sides of the hot slabs and of the intermediate piece, or the intermediate pieces, respectively, that are in each case to be welded to one another by pendular friction welding and/or vibration friction welding according to the invention can be moved relative to one another in an at least largely parallel or a precisely parallel manner, this being associated with uniform contact between the joining sides and, on account thereof, with an improved, in particular a more uniform, welding outcome, or joining outcome, respectively.

Pendular friction welding is to be understood as a welding procedure in which the single intermediate piece, or the separate intermediate pieces, respectively, is/are in each case moved in an oscillating, thus pendular, manner on an orbit with a large radius, the oscillating movement of the respective intermediate piece being generated on account thereof. The radius is chosen to be so large that this can be considered an almost parallel movement. It is thus understood that the term “largely parallel” used may also comprise a minor orbit which results from a pendular movement. Vibration friction welding is understood to be a welding procedure in which the single intermediate piece, or the separate intermediate pieces, respectively, is/are moved in a reciprocating linear manner, the oscillating movement of the respective intermediate piece being generated on account thereof.

According to the method according to the invention, the mutually facing joining sides of the hot slabs by pendular friction welding and/or vibration friction welding are simultaneously joined in a materially integral manner to the single intermediate piece, or the separate intermediate pieces, respectively. It is thus a feature according to the invention that the respective intermediate piece is not first joined to one of the hot slabs and subsequently joined to the other hot slab, or to the other intermediate piece, respectively. The joining of the hot slabs can be carried out relatively rapidly on account thereof.

When joining the hot slabs by way of the single intermediate piece, two friction-welded joints which run so as to be at least largely mutually parallel are simultaneously generated on an ideally short strip length. By contrast, when joining the hot slabs by way of two or a plurality of separate intermediate pieces, three or more friction-welded joints which run so as to be at least largely mutually parallel are simultaneously generated on an ideally short strip length, wherein at least one of the friction-welded joints is configured between the separate intermediate pieces.

The use of the at least two separate intermediate pieces for joining the hot slabs has the advantage that the masses, or the moments of inertia of the masses, respectively, of the intermediate pieces which counter-oscillate in a mutual manner during the pendular friction welding or the vibration friction welding, respectively, compensate one another, or cancel one another, respectively, such that no oscillations arise from an external perspective. On account thereof, the constructive complexity for implementing the method according to the invention can additionally be significantly reduced.

The hot slabs which are joined to one another according to the method according to the invention, can be fed in succession to at least one roll stand or a multi-stand roll train. A continuous operation of the roll stand, or of the roll train, respectively, is guaranteed on account thereof, in particular since no interruptions of the rolling are required for the threading-in and threading-out of individual hot slabs to the roll stand, or to the roll train, respectively. On account thereof, the productivity of the roll stand, or of the roll train or of a metallurgical plant equipped therewith, for example an endless plant, a continuous plant, a CSP (compact strip production) plant, or the like, respectively, is increased and the technically achievable minimum final thickness is reduced. The hot slabs may have the same chemical composition or have dissimilar chemical compositions.

The hot slabs can in particular be thin slabs which in the non-rolled state can have a thickness of approximately ≤70 mm. The hot slabs can also be referred to as hot strips or as feed strips. However, the invention is not limited to the joining of hot slabs but can likewise also be used for joining hot metallic casting products such as, for example, billets or the like. For the sake of simplicity, all these hot metallic products in the context of the application are referred to as hot slabs without this being understood to be limiting.

According to one advantageous design embodiment, at least one of the separate intermediate pieces, respectively, is first severed from one of the hot slabs. On account thereof, the respective intermediate piece has the same chemical composition as the hot slab from which the former has been severed. The severing of the intermediate piece can take place by means of a set of shears which in a metallurgical plant is anyway present at a suitable location. The intermediate piece can thus be severed from an end of the hot slab and then used directly as an intermediate piece for indirectly joining the hot slab to a trailing or a leading hot slab. The intermediate piece prior thereto thus does not have to be stored or transported to the site. The separate intermediate pieces can be severed from a hot slab. Alternatively, the separate intermediate pieces can be severed from different hot slabs which are to be indirectly joined to one another.

One further advantageous design embodiment provides that an available residual hot slab piece is used as at least one of the separate intermediate pieces, respectively. This renders the utilization of residual pieces which would otherwise not be utilized possible, this reducing the material waste, or the disposal of waste, respectively. It is also possible for an intermediate piece by way of which an optimal joint of hot slabs with dissimilar chemical compositions is producible to be selected among different residual pieces, a mixed joint thus being producible by said intermediate piece.

According to one further advantageous design embodiment a composition of the single intermediate piece, or of at least one of the separate intermediate pieces, respectively, is selected in such a manner that the composition corresponds to a composition of the hot slabs, or differs from the composition of at least one hot slab. For example, mixed joints between slabs with dissimilar chemical compositions can be produced by way of dissimilar chemical compositions of the respective intermediate piece and the hot slab to be welded to the latter. The chemical composition of the respective intermediate piece herein can also differ from the dissimilar chemical compositions of the hot slabs. The chemical compositions of the separate intermediate pieces can also differ from one another.

A device according to the invention for joining hot slabs which are able to be fed in succession to at least one roll stand comprises at least one holding installation for holding a first hot slab and a second hot slab such that joining sides of the hot slabs are disposed so as to face one another and be mutually spaced apart; and at least one oscillation installation for holding a single metallic intermediate piece, in advance separated from one of the hot slabs or formed by an existing slab remnant, between the joining sides, and for generating an oscillating movement of the intermediate piece in a manner at least largely parallel to the joining sides; wherein the holding installation at least during the oscillating movement of the intermediate piece is conceived for pressing the joining sides against the intermediate piece.

The advantages which have been mentioned above in the context of the method according to the invention are associated in analogous manner with the device. The device can in particular be used for carrying out the method according to one of the above-mentioned design embodiments or an arbitrary combination of at least two of said design embodiments with one another. For example, the holding installation can have a dedicated down-holding installation for each hot slab by way of which an end portion of the respective hot slab can be pressed against a roller table so as to hold the hot slab in a locationally fixed manner. The oscillation installation comprises mechanical means for firmly holding the single intermediate piece, and at least one drive unit for generating the oscillating movement of said mechanical means, or of the intermediate piece held by the latter, respectively.

A further device according to the invention for joining hot slabs which are able to be fed in succession to at least one roll stand comprises at least one holding installation for holding a first hot slab and a second hot slab such that joining sides of the hot slabs are disposed so as to face one another and be mutually spaced apart; and at least one oscillation installation for holding at least two separate metallic intermediate pieces in mutual physical contact and in series between the joining sides, and for generating counter-oscillating movements of the intermediate pieces in a manner at least largely parallel to the joining sides; wherein the holding installation at least during the oscillating movements of the intermediate pieces is conceived for pressing the joining sides against the intermediate pieces.

The advantages which have been mentioned above in the context of the method according to the invention are associated in analogous manner with the device. The device can in particular be used for carrying out the method according to one of the above-mentioned design embodiments or an arbitrary combination of at least two of said design embodiments with one another. For example, the holding installation can have a dedicated down-holding installation for each hot slab by way of which an end portion of the respective hot slab can be pressed against a roller table so as to hold the hot slab in a locationally fixed manner. The oscillation installation comprises mechanical means for respectively firmly holding the separate intermediate pieces, and at least one drive unit for generating the oscillating movement of said mechanical means, or of the intermediate pieces held by the latter, respectively.

The invention will be explained in an exemplary manner hereunder with reference to the appended figures by means of preferred embodiments, wherein the features illustrated hereunder may constitute an advantageous or refining aspect of the invention in each case individually or in various technically expedient combinations of at least two of these features with one another. In the figures:

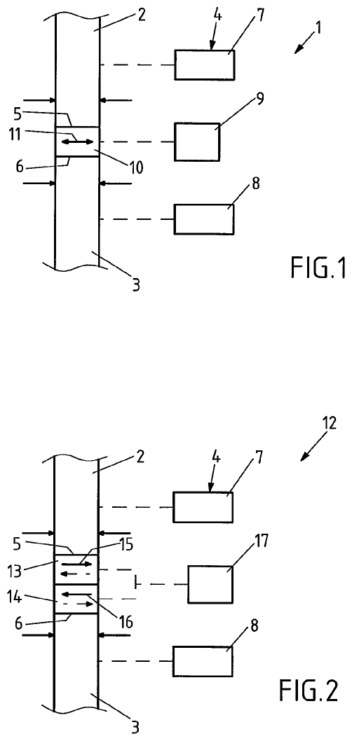

FIG. 1 shows a schematic illustration of an exemplary embodiment for a device according to the invention; and

FIG. 2 shows a schematic illustration of a further exemplary embodiment for a device according to the invention.

Identical components, or functionally equivalent components, respectively, are provided with the same reference signs in the figures. A repetition of the description of said components may be omitted.

FIG. 1 shows a schematic illustration of an exemplary embodiment for a device 1 according to the invention for joining hot slabs 2 and 3 which are able to be fed in succession to at least one roll stand (not shown).

The device 1 comprises a holding installation 4 for holding a first hot slab 2 and a second hot slab 3 such that joining sides 5 and 6 of the hot slabs 2 and 3 are disposed so as to face one another and be mutually spaced apart. To this end, the holding installation 4 comprises a dedicated holding unit 7 or 8, respectively, for each hot slab 2 or 3, respectively.

The device 1 furthermore comprises an oscillation installation 9 for holding a single metallic intermediate piece 10 between the joining sides 5 and 6, and for generating an oscillating movement of the intermediate piece 10 in a manner largely parallel or precisely parallel to the joining sides 5 and 6, said oscillating movement being indicated by the double arrow 11. The holding installation 4 at least during the oscillating movement of the intermediate piece 10 is conceived for pressing the joining sides 5 and 6 against the intermediate piece 10.

Prior thereto, the intermediate piece 10 may have been severed from one of the hot slabs 2 or 3, respectively. Alternatively, the intermediate piece 10 may be a residual hot slab piece already available. The composition of the intermediate piece can be selected in such a manner that the composition corresponds to a composition of the hot slabs 2 and 3, or differs from the composition of at least one hot slab 2 or 3, respectively.

FIG. 2 shows a schematic illustration of a further exemplary embodiment for a device 12 according to the invention for joining hot slabs 2 and 3 which are able to be fed in succession to at least one roll stand (not shown).

The device 12 differs from the exemplary embodiment shown in FIG. 1 in that the device 12 has an oscillation installation 17 for holding two separate metallic intermediate pieces 13 and 14 in mutual physical contact and in series between the joining sides 5 and 6, and for generating counter-oscillating movements of the intermediate pieces 13 and 14 in a manner largely parallel or precisely parallel to the joining sides 5 and 6, as is indicated by the arrow combinations 15 and 16. The vibration stresses on the holding installations 7 and 8 as well as on the oscillation installation 17 are canceled on account of the counter-oscillating movement. The holding installation 4 at least during the oscillating movements of the intermediate pieces 13 and 14 is conceived for pressing the joining sides 5 and 6 against the intermediate pieces 13 and 14.

### LIST OF REFERENCE SIGNS

1 Device
2 Hot slab
3 Hot slab
4 Holding installation
Joining side of 2
6 Joining side of 3
7 Holding unit of 4
8 Holding unit of 4
9 Oscillation installation
Intermediate piece
11 Double arrow (movement of 10)
12 Device
13 Intermediate piece
14 Intermediate piece
Arrow combination (oscillating movement of 13)
16 Arrow combination (oscillating movement of 14)
17 Oscillation installation

1-6. (canceled)

7. A method for joining hot slabs which are fed in succession to at least one roll stand, comprising the steps of:
separating in advance a single metallic intermediate piece from one of the hot slabs or using an existing slab remnant as the single metallic intermediate piece;
disposing the single metallic intermediate piece between mutually facing joining sides of the hot slabs; and
moving the single metallic intermediate piece in an oscillating manner at least largely parallel to the joining sides while pressing the joining sides against the intermediate piece and holding the joining sides in a locationally fixed manner so that the mutually facing joining sides of the hot slabs are simultaneously joined in a materially integral manner to the single metallic intermediate piece by pendular friction welding and/or vibration friction welding.

8. A method for joining hot slabs which are fed in succession to at least one roll stand, comprising the steps of:
disposing separate metallic intermediate pieces in series between mutually facing joining sides of the hot slabs; and
simultaneously joining each of the joining faces to at least one of the separate metallic intermediate pieces in a materially integral manner by pressing the intermediate pieces disposed in series between the joining sides against one another and moving the intermediate pieces in a mutually counter-oscillating manner at least largely parallel to the joining sides while pressing the joining sides against the intermediate pieces and holding the joining sides in a locationally fixed manner so that the mutually facing joining sides of the hot slabs are simultaneously joined in a materially integral manner to the single metallic intermediate piece by pendular friction welding and/or vibration friction welding.

9. The method according to claim 8, including severing in advance at least one of the separate intermediate pieces from one of the hot slabs.

10. The method according to claim 8, including using an available residual hot slab as at least one of the separate intermediate pieces.

11. The method according to claim 7, including selecting a composition of the single intermediate piece so that the composition corresponds to a composition of the hot slabs or differs from the composition of at least one hot slab.

12. The method according to claim 8, including selecting a composition of at least one of the separate intermediate pieces so that the composition corresponds to a composition of the hot slabs or differs from the composition of at least one hot slab.

13. A device for joining hot slabs which are fed in succession to at least one roll stand, comprising:
at least one holding installation for holding a first hot slab and a second hot slab so that joining sides of the hot slabs are disposed so as to face one another and be mutually spaced apart; and
at least one oscillation installation for holding a single metallic intermediate piece between the joining sides, and for generating an oscillating movement of the intermediate piece in a manner at least largely parallel to the joining sides, wherein the intermediate piece is separated in advance from a hot slab or formed by a remnant of an existing slab, wherein the holding installation is configured to press the joining sides against the intermediate piece at least during the oscillating movement of the intermediate piece.

14. A device for joining hot slabs which are fed in succession to at least one roll stand, comprising:
at least one holding installation for holding a first hot slab and a second hot slab so that joining sides of the hot slabs are disposed so as to face one another and be mutually spaced apart; and
at least one oscillation installation for holding at least two separate metallic intermediate pieces in mutual physical contact and in series between the joining sides, and for generating counter-oscillating movements of the intermediate pieces in a manner at least largely parallel to the joining sides, wherein the holding installation is configured to press the joining sides against the intermediate pieces at least during the oscillating movements of the intermediate pieces.
